(19) United States
(12) Patent Application Publication
(10) Pub. No.: US 2019/0104714 A1
(43) Pub. Date: Apr. 11, 2019

(54) Twist Lock Outrigger Mount and Security Fastener

(71) Applicant: Philip J. Serocki, Sparta, TN (US)

(72) Inventor: Philip J. Serocki, Sparta, TN (US)

(21) Appl. No.: 16/155,731

(22) Filed: Oct. 9, 2018

Related U.S. Application Data
(60) Provisional application No. 62/569,864, filed on Oct. 9, 2017.

(51) Int. Cl. A01K 91/08; A01K 97/10

(52) U.S. Cl. CPC A01K 91/08; A01K 97/10

(57) ABSTRACT

An outrigger having an outrigger arm with a tubular portion having an insertion end and an inside diameter, having a boss directed radially inward, and a butt having a longitudinal axis and a base end dimensioned for being received into the tubular portion in an insertion direction, the butt having a collar spaced from the base end, and a substantially J-shaped slot opening out at the base end for receiving the boss, the J-shaped slot having an insertion segment extending from the base end to a transverse segment extending circumferentially to a return segment extending to the base end, the return segment having an end wall, the boss bearing against the end wall in a secured position of the butt in the tubular portion in which the collar is spaced apart from the insertion end for defining a gap with a gap distance between the collar and the insertion end, a spring disposed in the tube portion for applying spring force against the butt opposite the insertion direction and seating the end wall against the boss in a secured position, a locking ring being removably mounted on the butt in the gap for preventing an axially displacement of the butt in the insertion direction precluding a movement of the butt into a rotation position.

### CROSS REFERENCE TO RELATED APPLICATIONS

This application claims benefit of U.S. Provisional Patent Application No. 62/569,864 filed Oct. 9, 2017, entitled Twist Lock Outrigger Mount and Security Fastener of which is incorporated herein by reference in its entirety.

### BACKGROUND OF THE INVENTION

### a) Field of the Invention

The invention lies in the field of fishing outriggers for guiding fishing lines while fishing. The invention pertains, more particularly, to a lock for preventing theft of outrigger poles/booms from a base assembly.

### b) Description of the Related Art

Outrigger poles are well known. Outrigger poles are costly due to the lengths thereof and the fact that modern poles are being manufactured from more costly material such as carbon fiber, which makes the outrigger poles attractive for theft. The outrigger poles are further attractive, because they are disposed on boats, which are often left unattended in easily accessible locations. U.S. Pat. No. 6,668,745 to Slatter discloses a pull pin for holding the pole in the attachment arm and preventing unintentional removal of the pole. Such construction provides no theft deterrence.

### SUMMARY OF THE INVENTION

It is accordingly an object of the invention to provide an outrigger arm locking device which overcomes a variety of disadvantages, including those mentioned above, of the heretofore-known devices and methods of this general type and which provides for an outrigger assembly that provides theft deterrence, is simple to use and is reliable.

With the foregoing and other objects in view there is provided, in accordance with the invention, an outrigger having an outrigger arm with a tubular portion having an insertion end and an inside diameter, having a boss directed radially inward, and a butt having a longitudinal axis and a base end dimensioned for being received into the tubular portion in an insertion direction, the butt having a collar spaced from the base end, and a substantially J-shaped slot opening out at the base end for receiving the boss, the J-shaped slot having an insertion segment extending from the base end to a transverse segment extending circumferentially to a return segment extending to the base end, the return segment having an end wall, the boss bearing against the end wall in a secured position of the butt in the tubular portion in which the collar is spaced apart from the insertion end for defining a gap with a gap distance between the collar and the insertion end, a spring disposed in the tube portion for applying spring force against the butt opposite the insertion direction and seating the end wall against the boss in a secured position, a locking ring being removably mounted on the butt in the gap for preventing an axially displacement of the butt in the insertion direction precluding a movement of the butt into a rotation position.

In accordance with another advantageous feature of the device of the invention, the locking ring is hinged and includes two halves each having a respective tab fastened to one another in a locking position by a screw, the screw having a patterned security head, the screw has a key with a profile matching the patterned security head to remove the screw.

In accordance with a further feature of the device of the invention, is a bearing disposed in the tubular portion, the bearing having a longitudinal slot for accommodating the boss

In accordance with an added preferred feature of the device of the invention the tubular portion has a stud at a bottom end thereof, the spring being disposed on the stud

In accordance with an added preferred feature of the device of the invention includes a pad slidably disposed on the stud, the pad being engaged by the base end of the butt for compressing the spring, the pad being retained on the stud by a screw threaded into the stud, the spring being disposed on the stud

Any desired combination of the invention described above and the advantageous embodiments of the invention described above likewise forms an advantageous embodiment of the invention.

Other features which are considered as characteristic for the invention are set forth in the appended claims.

Although the invention is illustrated and described herein as embodied in twist lock outrigger, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a section view through the outrigger and butt in a partially inserted position;

FIG. 2 is a section view from FIG. 6, through the outrigger with the butt in a locked position with a lock ring in place;

FIG. 3 is a section view from FIG. 5, through the outrigger with the butt in a removal or insertion position;

FIG. 4 is an exploded view of the outrigger arm, butt and lock ring;

FIG. 5 is a top view of the outrigger with the butt in a removal or insertion position;

FIG. 6 is top view of the outrigger with the butt in a locked position with the lock ring in place;

FIG. 7 is a plan view of a ring lock;

FIG. 8 is a section view through the ring lock;

FIG. 9 is an exploded view of the ring lock;

FIG. 10 is a side view of the ring lock showing the lock nut;

FIG. 11A is a side view of a key for the lock nut; and

FIG. 11B is an end view of the key for the lock nut.

### DESCRIPTION OF THE PREFERRED EMBODIMENTS

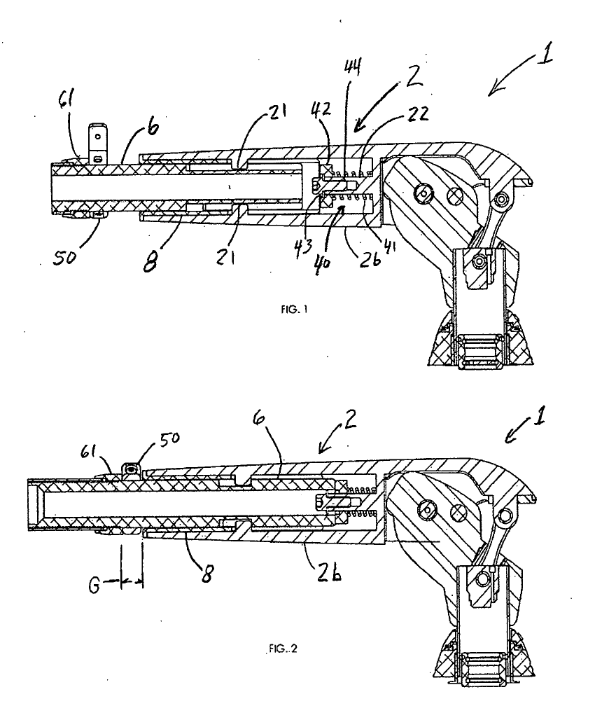

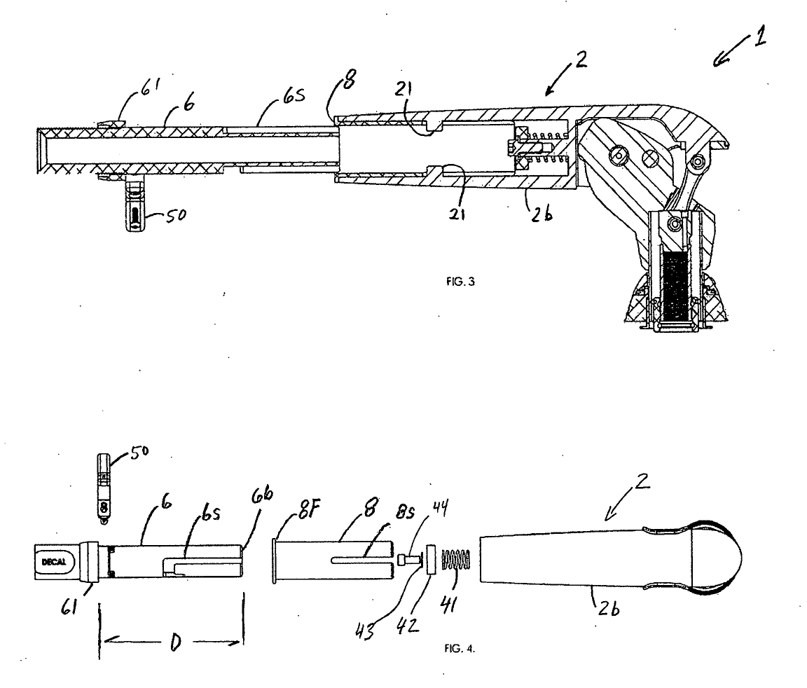

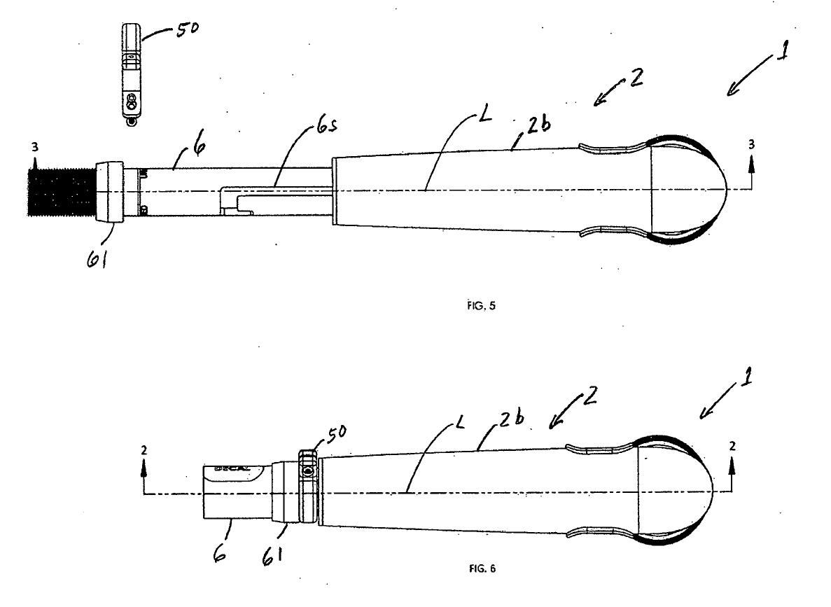

Referring now to the figures of the drawing in detail and first, particularly to FIG. 1, an outrigger 1 is seen. The outrigger 1 includes an upper arm assembly 2 having a tubular portion 2b. The tubular portion 2b has two protrusions or bosses 21 provided on an inside diameter of the tubular portion 2b. The bosses 21 are disposed opposite one another, preferably 180° apart.

The tube portion 2b may be provided with a bearing/liner 8 secured therein that is dimensioned to receive a base end 6b of an outrigger butt 6 with a slip fit. As seen in FIG. 4, the bearing 8 has opposing slots 8s to accommodate the two bosses 21 and allow the bearing 8 to be inserted down into the tubular portion 2b. The bearing 8 also has a flange 8f to seat against an insertion end of the tube portion 2b.

The base end 6b of the butt 6 is provided with two opposing substantially J-shaped grooves/slots 6s that are 180° apart and which open out in a circumferential edge of the base end 6b of the butt 6. The slots 6s receive and engage the bosses 21 as the butt 6 is inserted into said tube portion 2b. The J-shaped slots 6s each have an insertion segment extending along the longitudinal axis L of the butt 6 from the base end 6b to a transverse segment that extends circumferentially about the butt 6, which leads to a return segment that extends along the longitudinal axis back toward the base end 6b of the butt 6. The return segments receive the bosses 21 in the locked position of the butt 6, as is shown in FIG. 2.

In order to further secure the butt 6 in the tubular portion 2b, a bottom end of the tubular portion 2b has a spring loaded plunger assembly 40 that engages the base end 6b and presses end walls of the return segments of the J-shaped slots against the bosses 21. The plunger assembly 40 holds the end walls against the bosses 21 and prevents the butt 6 from being rotated. A rotation of the butt 6 requires overcoming a spring force of the plunger assembly 40 so that the transverse segment. In order to remove the butt 6, the spring force must be overcome to move butt 6 to a position where the transverse segments are aligned with the bosses 21 allowing a rotation of the butt 6 into a position where the insertion segments are aligned with the bosses 21 for removing the butt 6 from the tubular portion 2b

As seen in FIG. 1 the bottom end of the tubular portion is provided with a stud 22. The plunger assembly 40 includes a compression spring 41 placed over the stud 22. A pad 42 is slidably disposed on the stud 22 and abuts the spring 41. The spring 41 is pre-loaded by a pad 42, which is held in place by a washer 43 and a male connecter 44 such as a socket head cap screw that is fastened into a mating connector in the stud 22, i.e. a female thread. The base end 6b of the butt 6 has an inside diameter that allows the butt 6 to slide over the stud 22 and compresses the spring 41 as the insertion segments move along the bosses 21 until the transverse segments are reached. The transverse segments define a rotation position of the butt 6, as the butt 6 is rotated along the transverse segments, the butt 6 is pressed away from the bottom end of the tubular portion 2b until the return segments reach the bosses 21. Once the return segments are reached, the spring 41 displaces the butt 6 along the longitudinal axis until the end walls are seated against the bosses 21. Such position is the secured position or use position of the butt 6 in the upper arm assembly 2.

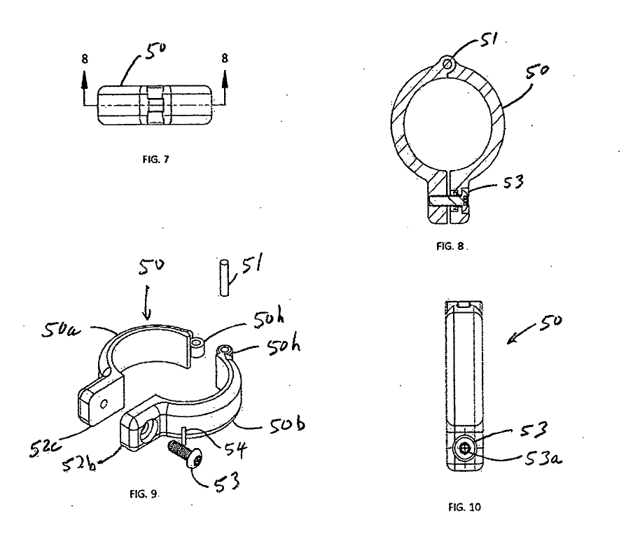

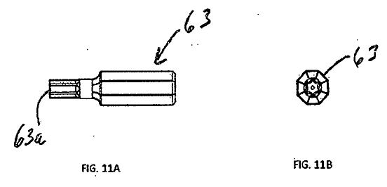

In order to maintain the butt 6 in the secured position or use position and prevent theft of the outrigger butt 6 and the corresponding outrigger pole a ring-shaped locking ring 50 is provided. The locking ring 50 has a hinge with a hinge pin 51 pivotably connecting the two halves 50a and 50b of the locking ring 50 to one another. The hinge pin 51 engages holes 50h formed in the respective halves 50a and 50b for securing the halves 50a and 50b to one another. At ends of the halves opposite the hinge, each of the halves is provided with a respective tab 52a, 52b, which sit face to face with one another in a closed position of the locking ring 50, see FIG. 8. One of the tabs is provided with a clearance hole and counterbore for a locking screw 53 and the remaining tab has a female thread for the locking screw 53. The locking screw 53 is provided with a patterned key head, which requires a mating key 63 to tighten and loosen remove the screw 53. Particularly, the pattern of the female key head 53a of the screw 53 matches the pattern on the male end 63a of the key 63. As seen FIG. 8, the screw 53 may be provided with a rubber washer 54, which prevents the screw 53 from being lost once unscrewed from the opposite half. The washer 54, may be accommodated in a further counterbore.

The butt 6 includes a collar 61 spaced from the base end 6b at a distance D that allows the butt 6 to be sufficiently displaced to the rotation position (at the transverse segments) where the butt 6 can be rotated and removed from the tubular portion 2b. The position of the collar 61 results in a gap G between the collar 61 and a free end of the tubular portion 2b in the secured position, see FIG. 2. The collar 61 may be threaded onto butt 6 by a female thread. The collar 61 can have a counterbore that defines a shoulder that abuts a step portion of the butt to set the position of the collar 61 on the butt 6 to define the gap G. The locking ring 50 is dimensioned to fit over the butt 6 and fill the gap G with minimal clearance thus preventing the butt 6 from being depressed into the rotation position, thus locking the butt 6 to the to the arm assembly 2. Once the locking ring 50 is disposed in the gap and the tabs 52a, 52b are brought together with one another and the screw 53 is inserted and tightened with the key 63. This fills the gap G and prevents the butt from being depressed to the rotation position and locks the outrigger butt 6 to the arm assembly 2. Specifically, as seen in FIG. 2, the clearance remaining in the gap G is less than the distance between the transverse segments and the bosses 21, which prevents the transverse segments from reaching the bosses 21 when the locking ring 50 is in place.

I claim:

1. An outrigger assembly comprising:
an outrigger arm having a tubular portion, said tubular portion having an insertion end and an inside diameter, said inside diameter having a boss directed radially inward;
a butt having a longitudinal axis and a base end dimensioned for being received into said tubular portion in an insertion direction, said butt having a collar spaced from said base end, said butt having a substantially J-shaped slot opening out at said base end for receiving the boss therein, said J-shaped slot having an insertion segment extending from said base end to a transverse segment extending circumferentially to a return segment extending to said base end, said return segment having an end wall, said boss bearing against said end wall in a secured position of said butt in said tubular portion, in which said collar is spaced apart from said insertion end for defining a gap with a gap distance between said collar and said insertion end;
a spring disposed in said tube portion for applying spring force against said butt opposite said insertion direction and seating said end wall against said boss in the secured position;
a locking ring being removably mounted on said butt in said gap for preventing an axially displacement of said butt in said insertion direction and precluding a movement of said butt into a rotation position where said transition segment is aligned with said boss.

2. The outrigger assembly according to claim 1, wherein said locking ring is hinged and includes two halves each having a respective tab fastened to one another in a locking position by a screw, said screw having a patterned security head, said screw has a key with a profile matching said patterned security head to remove said screw.

3. The outrigger assembly according to claim 1, further comprising a bearing disposed in said tubular portion, said bearing having a longitudinal slot for accommodating said boss.

4. The outrigger assembly according to claim 1, wherein said tubular portion has a stud at a bottom end thereof, said spring being disposed on said stud.

5. The outrigger assembly according to claim 4, further comprising a pad slidably disposed on said stud, said pad being engaged by said base end of said butt for compressing said spring, said pad being retained on said stud by a screw threaded into said stud, said spring being disposed on said stud.
